(19) United States
(12) Patent Application Publication
(10) Pub. No.: US 2009/0171836 A1
(43) Pub. Date: Jul. 2, 2009

(54) SYSTEM AND METHOD FOR IDENTIFICATION VERIFICATION OVER A FINANCIAL NETWORK

(75) Inventors: Hugo Olliphant, San Francisco, CA (US); Matthew Mengerink, San Jose, CA (US); German Scipioni, San Jose, CA (US)

Correspondence Address: Haynes and Boone, LLP;IP Section, 2323 Victory Avenue, SUITE 700, Dallas, TX, 75219, US

(73) Assignee: eBay Inc.

(21) Appl. No.: 11/966,841

(22) Filed: Dec. 28, 2007

(51) Int. Cl. G06Q 40/00

(52) U.S. Cl. 705/39

(57) ABSTRACT

A system and method for identification verification over a network is described herein. In one embodiment, the system for identification verification over a network comprises a communication interface; and a payment provider system configured to receive via the communication interface an image of an individual from a merchant system, verify the image received from the merchant system by comparing the image received with a known good image of the individual, and indicated one of positive identification or negative identification back to the merchant system.

### BACKGROUND

1. Field of the Invention

The present invention generally relates to financial transactions and more particularly to identification verification over a financial network.

2. Related Art

In direct (face-to-face) or online financial transactions, customers search for and purchase products and services from a merchant. In the case of online shopping, transactions are conducted through electronic communications with online merchants over electronic networks, such as the Internet. During the course of these transactions, customers may provide payment in various ways including, for example, cards, electronic fund transfers, and other payment techniques offered by payment providers.

Typically, when online shopping at a particular website, customers select items to purchase by clicking on a link for a specific item. When done shopping, the customer proceeds to a checkout page to provide some form of payment for the selected items. At this point in the process, the customer typically further provides some form of identification. When the customer continues shopping and is ready to purchase items from another website, the payment and identification process is repeated.

However, in many financial transactions the customer has no identification, provides inadequate identification, i.e., does not include a photo or similar form of identification, etc., or, if identification is presented, the identification is falsified is some manner. Accordingly, at least in the case of falsified identification or identity theft (use of someone else's identification) merchants, as well as, individuals whose identities have been compromised are typically impacted through lost revenue or inventory, bad credit, and/or some type of business and/or personal detriment.

Accordingly, there exits a need for an improved system and method for identification verification over a financial network.

### SUMMARY

For purposes of summarizing the disclosure, exemplary embodiments of a system and method for identification verification over a financial network have been described herein.

In one embodiment, a system for identification verification over a network comprises a communication interface; and a payment provider system configured to receive via the communication interface an image of an individual from a merchant system, verify the image received from the merchant system by comparing the image received with a known good image of the individual, and indicated one of positive identification or negative identification.

In another embodiment, a network payment provider system includes an identification database having a plurality of known good images of a plurality of individuals. The payment provider system is configured to receive a request from a merchant system for one of the plurality of known good images of one of the plurality of individuals, and transmit the requested image to the merchant system to facilitate identification verification by the merchant in a financial transaction.

In still another embodiment, a method for identification verification over a payment network comprises receiving an image of an individual from a merchant system during a financial transaction via a communication interface; comparing the image received with a known good image of the individual; and indicating one of positive identification or negative identification back to the merchant system to facilitate completion of the financial transaction.

These and other embodiments will be more readily apparent from the detailed description of the embodiments set forth below taken in conjunction with the accompanying drawings.

### BRIEF DESCRIPTION OF THE DRAWINGS

FIG. 1 shows a block diagram of a networked system configured to facilitate online financial transactions.

FIG. 2 shows a block diagram of a networked system for identification verification in accordance with one embodiment.

FIG. 3 shows a block diagram of a networked system for identification verification in accordance with another embodiment.

FIG. 4 shows one embodiment of a method for identification verification over a network in reference to the client system.

FIG. 5 shows one embodiment of a method for identification verification over a network in reference to the payment provider system.

Embodiments of the disclosure are understood by referring to the detailed description that follows. It should be appreciated that like reference numerals are used to identify like elements illustrated in one or more of the figures, wherein showings therein are for purposes of illustrating embodiments and not for purposes of limiting the same.

### DETAILED DESCRIPTION

Exemplary embodiments will now be described with references to the accompanying figures, wherein like reference numbers refer to like elements throughout. The terminology used in the description presented herein is not intended to be interpreted in any limited or restrictive manner simply because it is being utilized in conjunction with a detailed description of certain embodiments.

Embodiments of the present disclosure are described herein as they may relate to an electronic payment system environment. An electronic payment system is generally considered as any kind of network service that includes the exchange of money for goods or services. Such network payment system includes, for example, card systems such a credit and/or debit card processing system for facilitating an online or web-based financial transaction. However, persons of ordinary skill in the art will understand that the teachings of the present disclosure apply equally to a financial transaction that occurs directly between a buyer and a merchant such as in a face-to-face transaction that may occur in department store or similar type business environment.

In one embodiment, the network may be implemented as a single network or a combination of multiple networks. For example, in various embodiments, the network may include the Internet and/one or more intranets, landline networks, wireless networks, and/or other appropriate types of communication networks. In another example, the network may comprise a wireless telecommunications network (e.g., cellular phone network) adapted to communicate with other communication networks, such as the Internet.

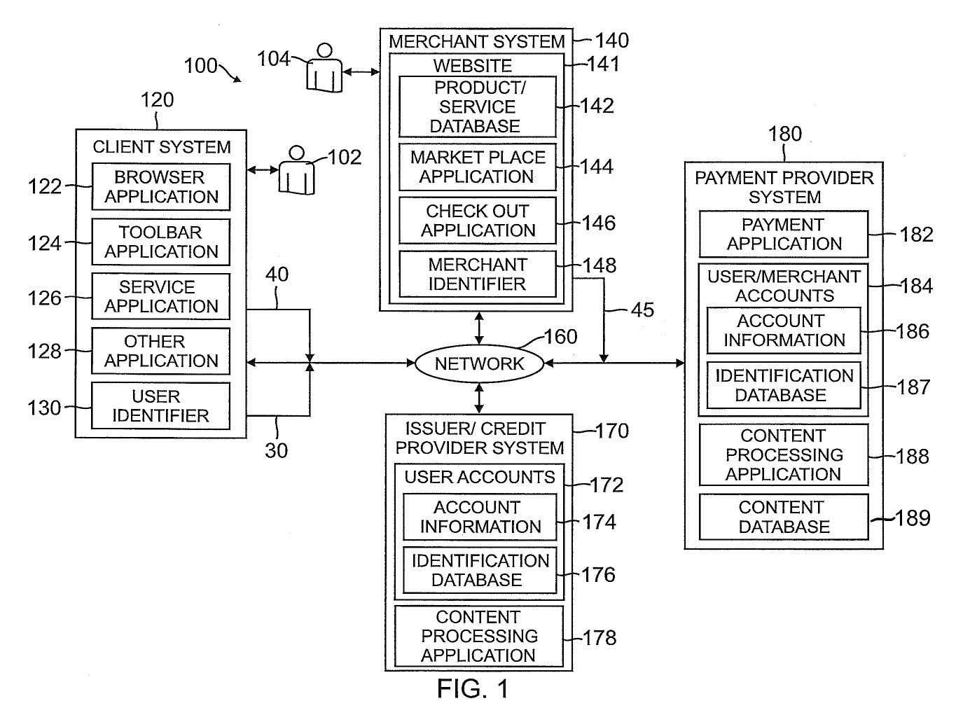

As generally shown in FIG. 1, a network system such as a card system may include a client system 120 (also referred to as a “user” system herein), a merchant system 10 having a merchant provided website 141 for the sale of goods and/or services, a payment provider system 180, and a card issuer system 170, wherein the flow of information and money between the parties in the financial transaction occurs along a network 160 such as the Internet.

Generally, in the card system, a user 102 (e.g., “buyer”, “client”, or “cardholder”) is issued credit 30 after an account has been approved by an issuer system 170 such as a financial institution (bank) or other organization. The issuer system 170 registers the user 102, issues a card(s), and operates a card account 172 to which payments can be charged. The user 102 is able to make purchases with the card for products and/or services from a merchant 104 accepting the card up to a pre-established credit limit.

In a typically financial transaction, the user 102 chooses one of multiple funding instruments 40, such as a card, to pay for the purchase of an item (product and/or service) and the merchant 104 submits the transaction for authorization 45. The issuer system 170 may act directly with the merchant system 140 for card authorization. However, as there are many issuer systems, it is generally more efficient for a payment provider system 180 to provide card services to the merchant system 140. In this regard, the merchant system 140 establishes a connection with the payment provider system 180. Connections may be made through an application programming interface (API) for card verification and processing. The APIs are generally HTTP or TCP/IP based and provide a relatively simple interface to communicate with the merchant's application software.

In this regard, the payment provider system 180 may provide payment processing for online transactions on behalf of the user 102 so that the user 102 does not expose his payment information directly to the merchant system 140. Instead the user 102 registers his account information with the payment provider system 180, maps the account to an email address or other personal identifier, and then uses the payment provider system 180 to make purchases when redirected to the payment provider system 180 from the merchant's site 141. After the transaction is authorized 45 the payment provider system 180 completes the online transaction, while the user 102 is directed back to the merchant's site 141 to an order confirmation page.

More specifically, the client system 120 may include one or more browser applications 122 which may be used, for example, to provide a user interface to permit the user 102 to browse information available over the network 160; one or more toolbar applications 124 displaying a graphical user interface (GUI) in connection with the browser application 122 to provide client-side processing for performing tasks in response to operations selected by the user 102; and a service application 126 comprising a software program for facilitating financial transactions, e.g., the direct purchase of items (products and/or services) on the network 160.

The service application 126 typically comprises a software program, such as the GUI, executable by a processor that is configured to interface and communicate with the one or more merchant systems 140 and the payment provider system 180 via the network 160. The service application 126 is configured to provide and display a payment mechanism, such an image or icon, on a display component (e.g., monitor) of the client system 120. The user 102 is able to access merchant websites 141 via merchant systems 140 to view and select items for purchase by communicating with the payment provider 180.

The client system 120 may include other applications 128 as may be desired in particular embodiments to provide additional features available to the user 102. For example, such other applications 128 may include security applications for implementing client-side security features, programmatic client applications for interfacing with appropriate application programming interfaces (APIs) over the network 160 or various other types of generally known programs and/or applications.

The client system 120 may include one or more user identifiers 130, which may be implemented, for example, as operating system registry entries, cookies associated with the browser application 122, identifiers associated with hardware of the client system 120, or various other appropriate identifiers. The user identifier 130 may include attributes related to the user, such as personal information and banking information. In various implementations, the user identifier 130 may be passed with a user purchase request to the payment provider 180, and the user identifier 130 may be used by the payment provider 180 to associate the user 102 with a particular user account maintained by the payment provider 180.

As shown in FIG. 1, one or more merchant systems 140 are maintained by merchants 104 offering various items (products and/or services) in exchange for financial payment or other consideration to be received from users, such as user 102, over the network 160. In this regard, each one of the one or more merchant systems 140 may include a database 142 for identifying available products and/or services, which may be made available to the client system 120 for viewing and purchase by the user 102. Accordingly, each of the merchant systems 140 may include a marketplace application 144 configured to provide information over the network 160 to the browser application 122 of the client system 120. For example, the user 102 may interact with the marketplace application 144 through the browser application 122 over the network 160 to search and view various items, products and/or services identified in the database 142.

Each of the one or more merchant systems 140 may include a checkout application 146 configured to accept payment information from the user 102 and/or from the payment provider system 180 over the network 160 to facilitate online transactions of products and/or services identified by the marketplace application 144.

Each of the one or more merchant systems 140 may include one or more merchant identifiers 148, which may be included as part of the one or more items made available for purchase so that a particular item may be associated with a particular merchant 104. The merchant identifier 148 may include attributes related to the merchant 104, such as business and banking information. In various implementations, the merchant identifier 148 may be passed with a user purchase request to the payment provider system 180 when the user 102 selects a item for purchase and processing, and the merchant identifier 148 may be used by the payment provider system 180 to associate a particular item purchased with a particular merchant account maintained by the payment provider system 180.

Each of the one or more merchants 104 having a related merchant system 140 may need to establish a merchant account 184 with the payment provider system 180 so that the payment provider system 180 is able to process transactions having items offered for purchase by the merchants 104. When establishing a merchant account 184, each of the one or more merchants 104 may need to provide business information, such as name, address, phone number, etc., and financial information, such as banking information, merchant account information, card information, payment processing information, etc.

Each of the one or more merchant systems 140 may be associated with a particular link (e.g., a link, such as a URL (Uniform Resource Locator) to an IP (Internet Protocol) address). In this regard, the payment provider system 180 may optionally redirect the browser application 122 to an appropriate webpage and/or merchant site 141 of the merchant server 140 to facilitate purchase of a corresponding item made available from at least one of the merchant systems 140.

The payment provider system 180 may provide payment processing for online transactions on behalf of the user 102 to an operator of the merchant system 140. In this regard, the payment provider system 180 includes one or more payment applications 182, which may be configured to interact with the client device 120 and/or each of the merchant servers 140 over the network 160 to facilitate the purchase of items by the user 102 from the merchant system 140.

The payment provider system 180 may be configured to maintain a plurality of user and merchant accounts 184, each of which may include account information 186 associated with individual users, including the user 102, and the one or more merchants 104 associated with the merchant servers 140. For example, account information 186 may include private financial information of user 102 and merchants 104, such as one or more account numbers, passwords, card information, banking information, or other types of financial information, which may be used to facilitate online transactions between the user 102 of the client system 120 and one or more merchants 104 associated with the merchant systems 140. As such, the payment application 182 may be configured to interact with the one or more merchant systems 140 on behalf of the user 102 during a transaction with checkout application 146 without requiring the user 102 to provide account information 186 directly to the merchant system 140. In various embodiments, the methods and systems described herein may be modified to accommodate users and/or merchants that may or may not be associated with at least one existing user account and/or merchant account, respectively.

As shown in FIG. 1, in one method for conducting a client-side online transaction the service application 126 may be installed and run on the client system 120 to allow the client system 120 to communicate with one or more of the merchant systems 140 via the network 160 to select an item for purchase.

Likewise, the service application 126 allows the client system 120 to further communicate with the payment provider system 180 to process online gift purchase requests for items selected for purchase and processing in a gift value transaction.

As indicated above, the user 102 may run the browser application 122 on the client system 120 to access at least one merchant website 141 via a related merchant system 140 to search the accessed merchant website 141 and view one or more gifts for purchase.

The user 102 may, for example, generate a purchase request for an item at the merchant's site 141. The purchase request may include user information, merchant information, and selected item information embedded as arguments in an expression that are passed to the payment provider system 180. The user information may include user identifier information, the merchant information may include the merchant identifier information, and the selected item information may include one or more image attributes, including item identifier information, having dynamic arguments identifying the item and the merchant providing the item.

The payment provider system 180 receives the purchase request including card data from the user 102 via the client system 120. Next, the payment provider system 180 verifies the user account information including user identification provided by the user 102 in the purchase request with user information stored in payment provider system 180.

In this regard, the payment provider system 180 validates the card and communicates with the issuer system 170 to verify the amount for the transaction is available in the customer's account or line of credit 174. Alternatively, as indicated above, the merchant system 140 may communicate with the issuer system 170 to obtain card authorization. In either case, if the card is good and the funds are available, an approved message is sent back to the merchant system 140. If the card is bad or if funds are not available, a declined message is sent back to the merchant system 140.

Once proper user identification has been provided and/or verified, and the funding instrument has been authorized the online purchase may be completed by deducting the amount of the purchase request from the user account and crediting the amount of the purchase request to the merchant account.

As indicated above, in many financial transactions online or face-to-face, such as those that typically occur when a merchant manages a cash register and/or a point-of-sale (POS) system, a user attempting to purchase an item has no identification, provides inadequate identification, i.e., does not include a photo or similar form of identification, etc., or, if identification is presented, the identification is falsified in some manner.

At least in the case of falsified identification or identity theft, merchants, as well as, individuals whose identities have been compromised are typically impacted through lost revenue or inventory, bad credit, and/or some type of business and/or personal detriment.

Embodiments of the disclosure overcome the deficiencies associated with an online financial transaction or a direct (face-to-face) transaction by providing an improved system and method of identification verification over a financial network.

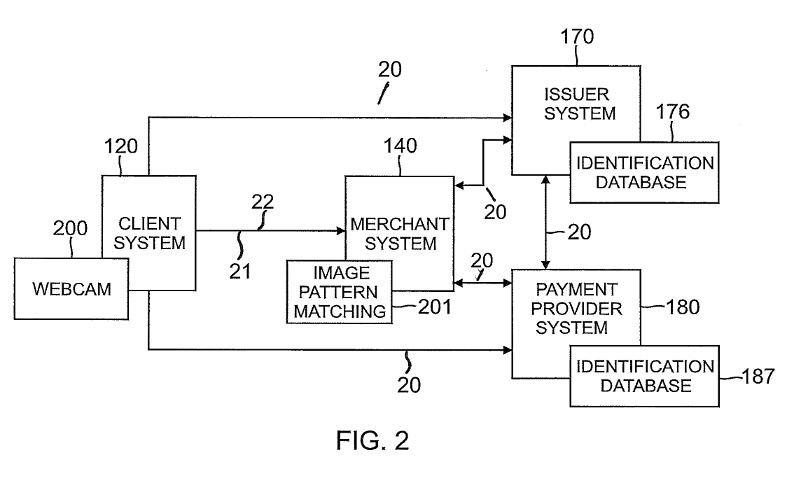

FIG. 2 shows a block diagram of a networked system for identification verification in accordance with one embodiment. As shown in FIG. 2, in order to obtain credit, i.e., receive credit approval and establish a card account 172 with the issuer system 170 and/or establish a user account 184 with the payment provider system 180, the user 102 is typically required to provide private financial information such as one or more account numbers, passwords, other card information, banking information, or other types of financial information, as well as, personal information such as name, age, residence location, etc. which may be stored in the corresponding identification database 176, 187 and used to facilitate online transactions.

In the embodiment shown in FIG. 2, the user 102 is further required to provide the issuer system 170 and/or the payment provider system 180 with a photograph or similar type image of the user's face. The photograph may be acquired through digital technology, a photo that is scanned and then sent, or that is mailed or otherwise provided to the issuer and/or payment provider systems 170, 180 and is later scanned and saved as a “known good image” to the corresponding identification database 176, 186. In some instances, multiple photographs including frontal, profile, three-quarter view, etc., may be required to capture various identifying features of a particular user 102.

Accordingly, in an online financial transaction, as indicated above, one or more browser applications 122 may be used to provide a user interface to permit the user 102 to browse information available over the network 160; one or more toolbar applications 124 displaying a graphical user interface (GUI) in connection with the browser application 122 to provide client-side processing for performing tasks in response to operations selected by the user 102; and a service application 126 comprising a software program for facilitating the financial transactions, e.g., the direct purchase of items (products and/or services) on the network 160.

At the time of online checkout, i.e., purchase of item, verification and authorization of credit, etc., the user 102 is required to provide a facial image for identification verification prior to completing the financial transaction. In one embodiment, the image may be provided to the merchant system 140 via a webcam 200 and corresponding software associated with the client system 120. Accordingly, the user 102 may be viewed by the merchant system 140 in real-time over the network or a snap-shot of the user 102 may be taken, downloaded, and viewed at the merchant system 140.

Once received by merchant system 140 the image may be matched to the known good image of the user 102 obtained from the issuer system 170 and/or the payment provider system 180. Such a know good image transfer from the issuer system 170 or the payment provider system 180 to the merchant system 140 may be facilitated by financial or other information (card, password, etc.) supplied by the user 102 to the merchant system 140 during checkout that is then matched to user information located in the user account databases 172, 184 of the issuer system 170 and/or the payment provider system 180.

In this regard, persons of ordinary skill in the art will understand that data flow pathways between the merchant system 140, issuer system 170, and payment provider system 180 to obtain the known good user image by the merchant system 140 within the network 160 may include, but not limited to, receiving the image directly from issuer system 170, or receiving the image directly from the payment provider system 180, which in either case the image may be communicated between the payment provider system 180 and the issuer system 170 prior to being obtained by the merchant system 140. Accordingly, in one embodiment, the payment provider system 180 may act as a centralized exchange for the storage of photos/picture/image identification in an open network where other issuers, merchants, and other businesses may request known good images for identification verification purposes in various financial and non-financial transactions.

Returning now to FIG. 2, after the known good user's image is received by the merchant system 140, the image may be compared and verified with the image received by the client system 120 via webcam 200. In this regard, image comparison may be done visually by a person, or the image comparison may be done using automated image pattern matching techniques 201 well-known in the art and typically used for finger print matching and other security functions.

If image comparison between the image received from the user 102 and the image received from the payment provider system 180 or the issuer system 170 results in a match or positive identification the purchase transaction may be completed (assuming credit approval). If however, image comparison between the image received from the user 102 and the image received from the payment provider system 180 or the issuer system 170 results in a mismatch or negative identification, the user 102 may be given another opportunity to provide an image for identification, the merchant may accept an alternative form of identification, or the purchase transaction may be terminated.

In an alternative embodiment, images of the user 102 received by the merchant system 140 at the time of the transaction may include multiple still-images or video images that may be stored and later recalled for to assist in resolving disputes that may arise later in which a customer claims that they did participate in a particular transaction, a transaction was incomplete, or inappropriately or inaccurately conducted by the merchant 104.

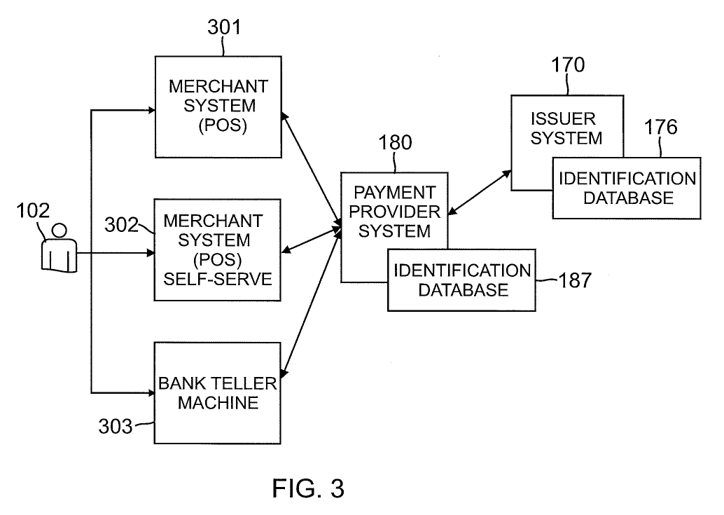

FIG. 3 shows a block diagram of a networked system for identification verification in accordance with another embodiment. As shown in FIG. 3, identification verification may take place during a direct transaction such as at a merchant point-of-sale (POS) terminal 301 either with a cashier available for visually comparing images for identification verification, or without a cashier as would occur in a self-service checkout situation 302 and the use of image pattern matching as indicated above. In a face-to-face image comparison, only a known good image of the individual would need to be obtained from the issuer system 170 or payment provider system 180 as the individual being identified may be viewed by the merchant 104 or other person representing the merchant in a financial transaction.

Similar to identification verification that would take place in a self-service checkout 302 situation without a merchant, identification verification may take place at other business venues such as a drive-up or automatic bank teller machine 303.

In each of the above-mentioned direct transaction schemes 301, 302, 303 a camera and associated image pattern recognition technology may be installed for identification verification. If a camera is currently installed at a particular location, as is typically the case with an automatic bank teller machine or a hotel registration desk, image pattern recognition technologies may be included and adapted to the existing camera to provide the necessary image acquisition for identification verification purposes. As explained above, once an image of the user 102 is captured, identification verification may be accomplished by visual or automated comparison methods.

Identification verification as described herein may be utilized in non-financial transactions. For example, a user 102 may contact the issuer system 170 or payment provider system 180 online to obtain a lost password. By image comparison either visually with the aid of webcam or similar technology or through the use of image pattern matching the issuer system 170 and/or payment provider system 180 would verify the user's identity and authorize communication of the password to the user 102.

In many instances, the use of identification verification prior to completion of a financial or non-financial transition may reduce the use of fraudulent identification as may occur in identity thefts before money, property, credit, or other detrimental loses occur.

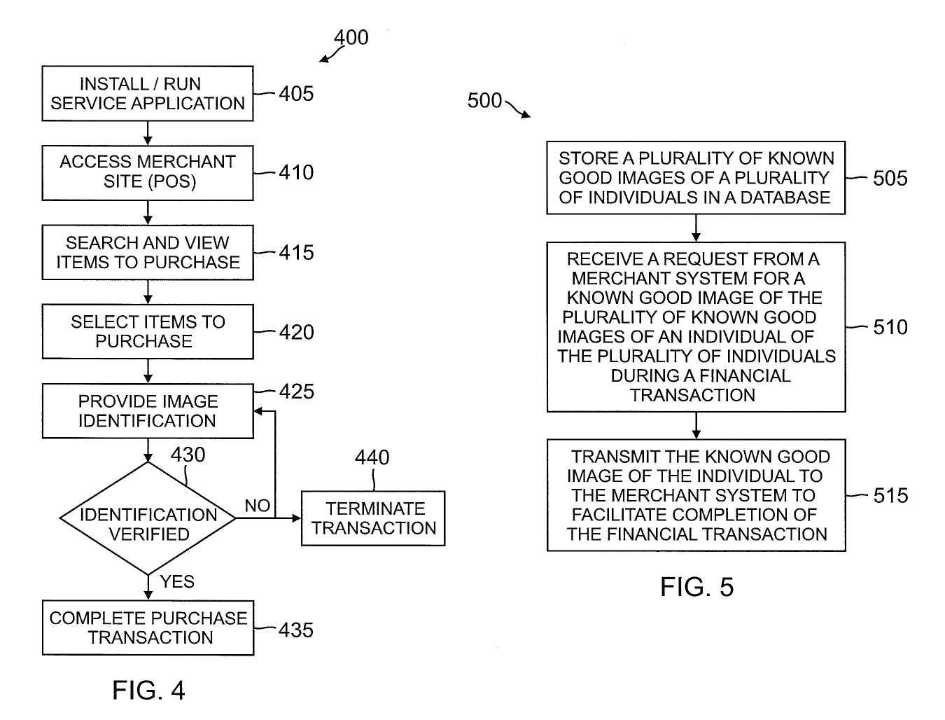

FIG. 4, shows one embodiment of a method 400 for identification verification over a network with reference to a client system.

As previously discussed, the service application 126 allows the client device 120 to communicate with one or more of the merchant systems 140 via the network 160 to select items for purchase and further communicate with the payment provider system 180 to process online purchase requests and/or transactions for items selected for purchase.

In one embodiment, upon user instruction, the service application 126 may be installed and/or run on the client device 120 (block 405) to access at least one merchant website 141 via a related merchant system 140 (block 410) to search the accessed merchant website 141 and view one or more items for purchase (block 415).

In one embodiment, upon installation, the user 102 may be prompted to establish a user account 184 with the payment provider system 180, wherein the user 102 may use the client device 120 to access the payment provider system 180 via the network 160. As indicated above, when establishing a user account 184, in addition to providing personal information, such as name, address, phone number, etc., and financial information, such as banking information, card information, etc., the user 102 is required to provide photo identification.

Next, the user 102 may generate a purchase request for at least one item by selecting the at least one item (block 420) from the merchant's site 141 and proceed to checkout. Methods of item selection (product and/or service) and communication of the purchase request including user information, merchant information, and selected item information to the payment provider system 180 for payment processing is generally well-known in the art.

Upon selection of one or more funding instruments 40 for the purchase of the at least one item, the user 102 further provides an image for identification via webcam or other well-known method to the merchant system (block 425). The payment provider system 180 matches data received relating to the funding instrument selected by the user 102 with user identification data including the previously provided known good photo image of the user 102 stored by the payment provider system 180 so that the known good image of the user 102 may be transmitted to the merchant system 140.

The image provided to the merchant system 140 is then verified and authorized by the merchant 104 and/or merchant system 140 as previously described. Persons of ordinary skill in the art will understand that as the payment provider system 180 and/or the issuer system 170 include an identification database 187, 176 having known good photo images of individuals/users stored therein, the identification verification process may be completed by the payment provider system 180 or issuer system 170 upon receiving an image of the user 102 from the merchant system 140.

If the identification of the user 102 is positive (block 430) the transaction may be completed (block 440). If the identification of the user 102 is negative (block 430), the user 102 may be given a second opportunity to provide an image for identification, an alternative form of identification may be accepted by the merchant (block 425) to complete the transaction, or the transaction may be terminated (block 440).

In a direct or face-to-face transaction at a merchant cash register or POS device the method would begin as indicated at block 410 and generally proceed as with an online transaction. That is, the user 102 would search and view items for purchase (block 415), select an item for purchase (block 420); proceed to checkout, provide funding instrument information and image identification (425); then, based on either a positive or negative result of the identification verification process (block 430); the transaction would be completed (435), the user 102 may be given a second opportunity to provide image identification, or the transaction would be terminated (440).

FIG. 5 shows one embodiment of a method 500 for identification verification over a network in reference to the payment provider system. As shown in FIG. 5, the payment provider system stores a plurality of known good images of a plurality of individuals in a database (block 505). The payment provider system then receives a request from the merchant system for a known good image of the plurality of images of an individual of the plurality of individuals during a financial transaction (block 510). In response to the request, the payment provider system transmits the known good image of the individual to the merchant system to facilitate completion of the financial transaction.

An alternative method for identification verification over a network in reference to the payment provider system comprises receiving an image of an individual from a merchant system during a financial transaction via a communication interface; comparing the image received with a known good image of the individual; and indicating one of positive identification or negative identification back to the merchant system to facilitate completion of the financial transaction. In contrast to the merchant system conducting the identification verification between a received image and a known good image, the embodiment just described, the payment provider system compares a received image and a known good image to determine identification verification over the network.

In accordance with various embodiments of the invention, a computer device or system, such as systems 120, 140, 170 and 180 described herein and which may further include a personal computer and/or a network server, includes a bus or other communication mechanism for communicating information, which interconnects subsystems and components, such as a processing component (e.g., processor, micro-controller, digital signal processor (DSP), etc.), system memory component (e.g., RAM), static storage component (e.g., ROM), disk drive component (e.g., magnetic or optical), network interface component (e.g., modem or Ethernet card), display component (e.g., CRT or LCD), input component (e.g., keyboard), and cursor control component (e.g., mouse or trackball). In one implementation, disk drive component may comprise a database having one or more disk drive components.

In accordance with embodiments of the invention, the computer system performs specific operations by a processor executing one or more sequences of one or more instructions contained in a system memory component. Such instructions may be read into system the memory component from another computer readable medium, such as a static storage component or a disk drive component. In other embodiments, hard-wired circuitry may be used in place of or in combination with software instructions to implement the subject matter disclosed herein.

Logic may be encoded in a computer readable medium, which may refer to any medium that participates in providing instructions to the processor for execution. Such a medium may take many forms, including but not limited to, non-volatile media, volatile media, and transmission media. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments, execution of instruction sequences to practice the invention may be performed by computer system. In various other embodiments of the invention, a plurality of computer systems coupled by communication link (e.g., network 160 of FIG. 1, LAN, WLAN, PTSN, or various other wired or wireless networks) may perform instruction sequences to practice embodiments in coordination with one another.

The computer system may transmit and receive messages, data, information and instructions, including one or more programs (i.e., application code) through a communication link and a communication interface. Received program code may be executed by the processor as received and/or stored in disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Although the method(s)/step(s) are illustrated and described herein as occurring in a certain order, the specific order, or any combination or interpretation of the order, is not required. Obvious modifications will make themselves apparent to those of ordinary skill in the art, all of which will not depart from the essence of disclosed subject matter, and all such changes and modifications are intended to be encompassed within the appended claims.

1. A system for identification verification over a network, comprising:
a payment provider system configured to provide payment processing services for one or more merchant systems on behalf of a client system, receive via a communication interface an image of an individual from one of the one or more merchant systems, verify the image received from the merchant system by comparing the image received with a known good image of the individual, and indicated one of positive identification or negative identification back to the merchant system.

2. The system of claim 1, wherein the known good image is obtained from an identification database of the payment provider system.

3. The system of claim 1, wherein identification database includes a plurality of the known good images corresponding to a plurality of individuals made available to a plurality of merchants upon request.

4. The system of claim 1, wherein the image is the face of the individual.

5. The system of claim 1, wherein the network is the Internet.

6. (canceled)

7. (canceled)

8. A system for identification verification over a network, comprising:
a payment provider system configured to provide payment processing services for one or more merchant systems on behalf of a client system and to receive via a communication interface a request for a known good image of an individual from one of the one or more merchant systems, and transmit the known good image to the merchant system to facilitate completion of the financial transaction.

9. The system of claim 8, wherein the known good image is obtained from an identification database of the payment provider system.

10. The system of claim 8, wherein identification database includes a plurality of the known good images corresponding to a plurality of individuals.

11. The system of claim 8, wherein the image is the face of the individual.

12. The system of claim 8, wherein the network is the Internet.

13. The system of claim 8, wherein the merchant system includes a point-of-sale device.

14. The system of claim 8, wherein the merchant system includes a self-service point-of-sale device.

15. A network system including an identification database having a plurality of known good images of a plurality of individuals, the network system configured to provide payment processing services for one or more merchant systems on behalf of a client system, receive a request from one of the one or more merchant systems for one of the plurality of known good images of one of the plurality of individuals, transmit the requested image to the merchant system to facilitate identification verification in a financial transaction.

16. The system of claim 15, wherein the network system is a payment provider system.

17. The system of claim 15, wherein the image is the face of the individual.

18. The system of claim 15, wherein the network is the Internet.

19. A payment provider system implemented method for identification verification over a payment network, the method comprising:
providing payment processing services for one or more merchant systems on behalf of a client system;
receiving an image of an individual from one of the one or more merchant systems during a financial transaction via a communication interface;
comparing the image received with a known good image of the individual; and
indicating one of positive identification or negative identification back to the merchant system to facilitate completion of the financial transaction,
wherein the method is performed by one or more processors of the payment provider system adapted to execute instructions stored on one or more memory components of the payment provider system.

20. The method of claim 19, further including obtaining the known good image from a database having a plurality of the known good images corresponding to a plurality of individuals.

21. A payment provider system implemented method for identification verification over a payment network, the method comprising:
providing payment processing services for one or more merchant systems on behalf of a client system;
storing a plurality of the known good images corresponding to a plurality of individuals in a database;
receiving a request from one of the one or more merchant systems for a known good image of the plurality of known good images of an individual of the plurality of individuals during a financial transaction via a communication interface; and
transmitting the known good image of the individual to the merchant system to facilitate completion of the financial transaction.
